(19) United States
(12) Patent Application Publication
(10) Pub. No.: US 2026/0142238 A1
(43) Pub. Date: May 21, 2026

(54) SECONDARY BATTERY AND METHOD OF MANUFACTURING SAME

(71) Applicant: Prime Planet Energy & Solutions, Inc., Tokyo (JP)

(72) Inventor: Tomonori MAEDA, Kobe-shi (JP)

(21) Appl. No.: 19/383,757

(22) Filed: Nov. 10, 2025

(30) Foreign Application Priority Data
Nov. 18, 2024 (JP) 2024-200829

(51) Int. Cl. H01M 10/0583; H01M 10/04; H01M 10/052; H01M 50/103; H01M 50/627

(52) U.S. Cl. CPC H01M 10/0583; H01M 10/0468; H01M 10/052; H01M 50/103; H01M 50/627

(57) ABSTRACT

A secondary battery includes an electrode assembly including an electrode and a separator, the electrode assembly having a first outer surface substantially orthogonal to a first direction, wherein a projecting portion protruding from the first outer surface and extending in a form of a line along a second direction in the first outer surface is formed on the first outer surface.

### CROSS REFERENCE TO RELATED APPLICATIONS

This nonprovisional application is based on Japanese Patent Application No. 2024-200829 filed on Nov. 18, 2024 with the Japan Patent Office, the entire contents of which are hereby incorporated by reference.

### BACKGROUND OF THE INVENTION

### Field of the Invention

The present technology relates to a secondary battery and a method of manufacturing the secondary battery.

### Description of the Background Art

Japanese Patent Laying-Open No. 2004-207253 discloses that a groove is formed in a surface of an electrode in a non-aqueous electrolyte secondary battery so as to improve diffusion of an injected electrolyte solution into a power generation element, discharging of gas from the power generation element, and a rate of removal of solvent from the power generation element.

### SUMMARY OF THE INVENTION

In a step of manufacturing a secondary battery, it has been required to improve an injection property for an electrolyte solution. On the other hand, it has been also required to improve reliability of the secondary battery. From the viewpoint of achieving both of them, there is still room for improvement in conventional secondary batteries. For example, when a groove is formed in an electrode as in the secondary battery described in Japanese Patent Laying-Open No. 2004-207253, gas may locally stay in the electrode, with the result that a metal such as lithium may be likely to be precipitated.

It is an object of the present technology to provide: a secondary battery having a high injection property and high reliability; and a method of manufacturing the secondary battery.

The present technology provides the following secondary battery and the following method of manufacturing the secondary battery.
[1] A secondary battery comprising an electrode assembly including an electrode and a separator, the electrode assembly having a first outer surface substantially orthogonal to a first direction, wherein a projecting portion protruding from the first outer surface and extending in a form of a line along a second direction in the first outer surface is formed on the first outer surface.
[2] The secondary battery according to [1], wherein a width of the projecting portion in a third direction orthogonal to the second direction in the first outer surface is 10 μm or more and 200 μm or less.
[3] The secondary battery according to [1] or [2], wherein a protruding height of the projecting portion from the first outer surface is 0.5 μm or more and 50 μm or less.
[4] The secondary battery according to any one of [1] to [3], wherein the first outer surface has a substantially rectangular shape including a long-side direction and a short-side direction, and the projecting portion is formed along the long-side direction.
[5] The secondary battery according to any one of [1] to [4], wherein the projecting portion is formed to reach the electrode located on an inner side of the electrode assembly with respect to the first outer surface in the first direction.
[6] The secondary battery according to any one of [1] to [5], wherein the first direction and the second direction are substantially orthogonal to each other.
[7] The secondary battery according to any one of [1] to [6], further comprising a case that accommodates the electrode assembly, wherein the case is provided with an injection hole for injecting an electrolyte solution, and the injection hole is provided in a surface of the case facing an end portion of the electrode assembly in the second direction.
[8] The secondary battery according to any one of [1] to [7], wherein three or more layers of the separator are layered at an outermost layer of the electrode assembly.
[9] The secondary battery according to any one of [1] to [8], wherein the separator includes a main body layer composed of a resin and an adhesive layer provided on the main body layer.

[10] The secondary battery according to any one of [1] to [9], wherein the electrode assembly includes a negative electrode tab provided at a first end portion of the electrode assembly in the second direction, and a positive electrode tab provided at a second end portion of the electrode assembly in the second direction, and the projecting portion is formed in the first outer surface at a position overlapping the negative electrode tab and the positive electrode tab in a third direction orthogonal to the second direction.

[11] The secondary battery according to any one of [1] to [9], wherein the electrode assembly includes a negative electrode tab provided at a first end portion of the electrode assembly in the second direction, and a positive electrode tab provided at a second end portion of the electrode assembly in the second direction, and the projecting portion is formed in the first outer surface at a position separated from the negative electrode tab and the positive electrode tab in a third direction orthogonal to the second direction.

[12] The secondary battery according to any one of [1] to [11], wherein the first outer surface has a substantially rectangular shape including a long-side direction corresponding to the second direction and a short-side direction corresponding to a third direction orthogonal to the second direction, an area of the first outer surface is 23000 mm² or more and 27000 mm² or less, and a size of the first outer surface in the second direction is three times or more and four times or less as large as a size of the first outer surface in the third direction.

[13] A method of manufacturing a secondary battery, the method comprising: preparing an electrode assembly including an electrode and a separator; and pressing the electrode assembly along a first direction, wherein the pressing the electrode assembly includes separately pressing a first region of the electrode assembly and a second region of the electrode assembly between which a boundary portion is sandwiched, so as to form a projecting portion protruding from a first outer surface of the electrode assembly in the boundary portion.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view showing a configuration of a secondary battery according to one embodiment.

FIG. 2 is a diagram showing a state in which the secondary battery shown in FIG. 1 is viewed in a direction of arrow II.

FIG. 3 is a diagram showing a state in which the secondary battery shown in FIG. 1 is viewed in a direction of arrow III.

FIG. 4 is a front cross sectional view of the secondary battery shown in FIG. 1.

FIG. 5 is a front view showing a negative electrode plate.

FIG. 6 is a front view showing a positive electrode plate.

FIG. 7 is a diagram showing a step of pressing an electrode assembly.

FIG. 8 is a front view showing the electrode assembly having been through the pressing step shown in FIG. 7.

FIG. 9 is a cross sectional view along IX-IX in FIG. 8.

FIG. 10 is a front view showing an electrode assembly according to a modification.

FIG. 11 is a cross sectional view along XI-XI in FIG. 10.

FIG. 12 is a diagram showing a step of injecting an electrolyte solution.

FIG. 13 is a diagram showing the injection step according to a modification.

FIG. 14 is a cross sectional view schematically showing a structure of the electrode assembly.

FIG. 15 is a cross sectional view showing a structure of a separator.

FIG. 16 is a diagram showing the separator folded in a meandering manner.

FIG. 17 is a diagram showing a positional relation between a projecting portion and a stepped portion of the separator.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

Moreover, sizes such as width, length, and diameter of each member illustrated in the present specification are not limited to those shown in the figures, and can be appropriately changed. In the present specification, ordinal numbers such as “first” and “second” may be given to respective configurations, but these ordinal numbers do not limit priority, order, or the like unless explicitly defined.

In the present specification, the term “battery” is not limited to a lithium ion battery, and may include other batteries such as a nickel-metal hydride battery and a sodium-ion battery. In the present specification, the term “electrode” may collectively represent a positive electrode and a negative electrode. Further, the term “electrode plate” may collectively represent a positive electrode plate and a negative electrode plate.

In the present specification, the term “battery cell” is not necessarily limited to a prismatic battery cell and may include a cell having another shape, such as a pouch battery cell or a blade battery cell. Further, the “battery cell” can be mounted on vehicles such as a hybrid electric vehicle (HEV), a plug-in hybrid electric vehicle (PHEV), and a battery electric vehicle (BEV). It should be noted that the use of the “battery cell” is not limited to the use in a vehicle.

### (Overall Configuration of Battery)

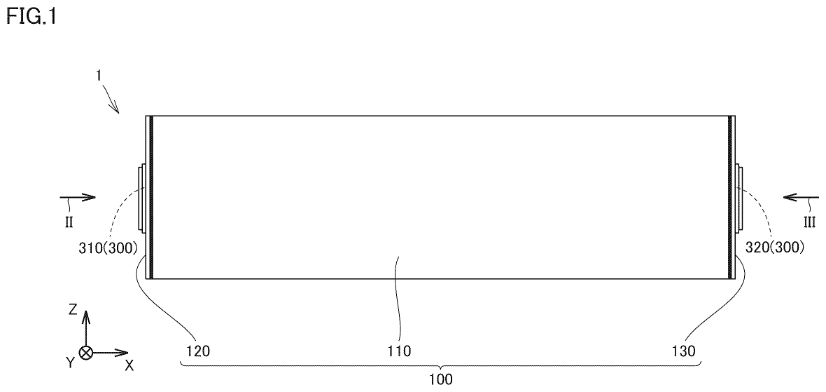

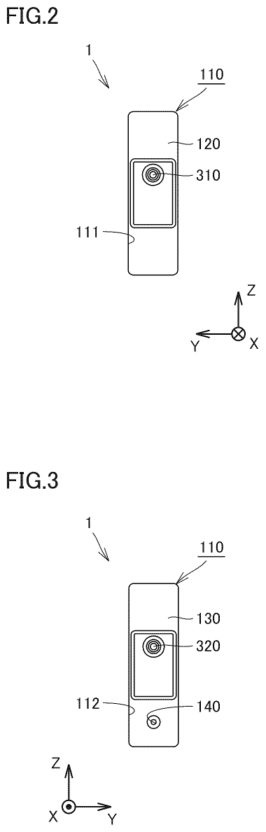

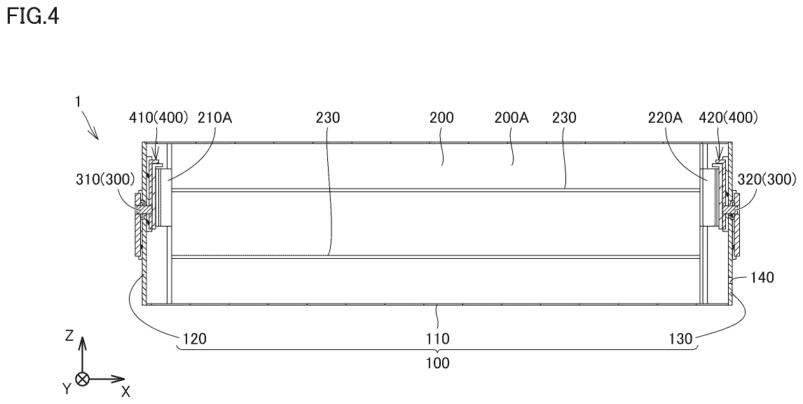

FIG. 1 is a front view of a secondary battery 1 according to one embodiment. FIGS. 2 and 3 are diagrams showing states in which secondary battery 1 (non-aqueous electrolyte secondary battery) shown in FIG. 1 is viewed in a direction of arrow II and a direction of arrow III, respectively. FIG. 4 is a front cross sectional view of secondary battery 1 shown in FIG. 1.

As shown in FIGS. 1 to 4, secondary battery 1 includes a case 100, an electrode assembly 200, electrode terminals 300, and current collectors 400. Case 100 includes case main body 110, a sealing plate 120, and a sealing plate 130.

When forming a battery assembly including secondary battery 1, a plurality of secondary batteries 1 are stacked in the thickness direction of each of the plurality of secondary batteries 1. Secondary batteries 1 stacked may be restrained in the stacking direction (Y direction) by a restraint member to form a battery module, or the battery assembly may be directly supported by a side surface of a case of a battery pack without using the restraint member.

Case main body 110 is constituted of a member having a tubular shape, preferably, a prismatic tubular shape. Thus, secondary battery 1 having a prismatic shape is obtained. Case main body 110 is composed of a metal. Specifically, case main body 110 is composed of aluminum, an aluminum alloy, iron, an iron alloy, or the like.

As shown in FIG. 1, sealing plate 120 and sealing plate 130 are provided at respective end portions of the case main body. Case main body 110 can be formed to have a prismatic tubular shape in, for example, the following manner: end sides of a plate-shaped member having been bent are brought into abutment with each other and are joined together (for example, laser welding). Each of the corners of the “prismatic tubular shape” may have a shape with a curvature.

In the present embodiment, case main body 110 is formed to be longer in the width direction (X direction) of secondary battery 1 than in each of the thickness direction (Y direction) and the height direction (Z direction) of secondary battery 1.

Case main body 110 includes a pair of long side surfaces and a pair of short side surfaces. The pair of long side surfaces and the pair of short side surfaces are provided to intersect (to be substantially orthogonal to) each other. The pair of long side surfaces and the pair of short side surfaces are connected at their respective end portions. Each of the pair of long side surfaces has an area larger than that of each of the pair of short side surfaces. A gas-discharge valve (not shown) is provided in one short side surface of the pair of short side surfaces. The gas-discharge valve is fractured preferentially to discharge a gas in case 100 to outside when pressure in case 100 becomes equal to or more than a predetermined value.

As shown in FIG. 2, an opening 111 is provided at an end portion of case main body 110 on one side in the X direction. Opening 111 is sealed by sealing plate 120. Each of opening 111 and sealing plate 120 has a substantially rectangular shape in which the Y direction corresponds to its short-side direction and the Z direction corresponds to its long-side direction. It should be noted that the substantially rectangular shape includes a rectangular shape or a generally rectangular shape such as a rectangular shape having corners each with a curvature. A negative electrode terminal 310 is provided on sealing plate 120. The position of negative electrode terminal 310 can be appropriately changed.

As shown in FIG. 3, an opening 112 is provided at an end portion of case main body 110 on the other side in the X direction. Opening 112 is located at an end portion opposite to opening 111, and openings 111, 112 face each other in the X direction. Opening 112 is sealed by sealing plate 130. Each of opening 112 and sealing plate 130 has a substantially rectangular shape in which the Y direction corresponds to its short-side direction and the Z direction corresponds to its long-side direction. Sealing plate 130 is provided with a positive electrode terminal 320 and an injection hole 140. The positions of positive electrode terminal 320 and injection hole 140 can be appropriately changed.

Each of sealing plate 120 and sealing plate 130 is composed of a metal. Specifically, each of sealing plate 120 and sealing plate 130 is composed of aluminum, an aluminum alloy, iron, an iron alloy, or the like.

Negative electrode terminal 310 is electrically connected to a negative electrode of electrode assembly 200. Negative electrode terminal 310 is attached to sealing plate 120, i.e., case 100. Positive electrode terminal 320 is electrically connected to a positive electrode of electrode assembly 200. Positive electrode terminal 320 is attached to sealing plate 130, i.e., case 100.

Negative electrode terminal 310 is composed of a conductive material (more specifically, a metal), and can be composed of copper, a copper alloy, or the like, for example. A portion or layer composed of aluminum or an aluminum alloy may be provided at a portion of an outer surface of negative electrode terminal 310.

Positive electrode terminal 320 is composed of a conductive material (more specifically, a metal), and can be composed of aluminum, an aluminum alloy, or the like, for example.

Injection hole 140 is sealed by a sealing member (not shown). As the sealing member, for example, a blind rivet or another metal member can be used.

As shown in FIG. 4, case 100 accommodates electrode assembly 200. Electrode assembly 200 is accommodated in case 100 such that the long-side direction thereof is parallel to the X direction. Electrode assembly 200 is accommodated in case 100 together with a below-described electrolyte solution 500. Electrode assembly 200 may be obtained by stacking a plurality of electrode assemblies. Electrode assembly 200 includes a main body portion having a substantially rectangular shape, a negative electrode tab group 210A, and a positive electrode tab group 220A.

The main body portion of electrode assembly 200 is constituted of a below-described negative electrode plate 210, a below-described positive electrode plate 220, and a below-described separator 240. Each of negative electrode tab group 210A and positive electrode tab group 220A is formed to protrude from the main body portion of electrode assembly 200 toward sealing plate 120 or sealing plate 130.

The main body portion of electrode assembly 200 has an outer surface 200A (first outer surface) substantially orthogonal to the Y direction (first direction). Electrode assembly 200 has projecting portions 230 each protruding from outer surface 200A in the Y direction. In the example of FIG. 4, each of projecting portions 230 is formed to extend in the form of a line along the X direction (second direction). In the example shown in FIG. 4, two projecting portions 230 are formed side by side in the Z direction (third direction). The arrangement of projecting portions 230 is not limited to the one illustrated in FIG. 4.

Outer surface 200A of electrode assembly 200 has a substantially rectangular shape including a long-side direction (X direction) and a short-side direction (Z direction). In the example of FIG. 4, each of projecting portions 230 is formed along the long-side direction (X direction).

Negative electrode tab group 210A is provided at one end portion (first end portion) in the X direction, and positive electrode tab group 220A is provided at the other end portion (second end portion) in the X direction. In the example of FIG. 4, projecting portion 230 is formed at a position overlapping negative electrode tab group 210A and positive electrode tab group 220A in the Z direction.

However, projecting portion 230 may be formed at a position separated from negative electrode tab group 210A and positive electrode tab group 220A in the Z direction. Moreover, in the Z direction, negative electrode tab group 210A and positive electrode tab group 220A may be formed at different positions, and projecting portion 230 may be formed at a position overlapping one of negative electrode tab group 210A and positive electrode tab group 220A and separated from the other of negative electrode tab group 210A and positive electrode tab group 220A.

Current collectors 400 include a negative electrode current collector 410 and a positive electrode current collector 420. Electrode assembly 200 is electrically connected to negative electrode terminal 310 and positive electrode terminal 320 through current collectors 400.

Negative electrode current collector 410 is disposed on sealing plate 120 with an insulating member composed of a resin being interposed therebetween. Negative electrode current collector 410 is electrically connected to negative electrode tab group 210A and negative electrode terminal 310.

Positive electrode current collector 420 is disposed on sealing plate 130 with an insulating member composed of a resin being interposed therebetween. Positive electrode current collector 420 is electrically connected to positive electrode tab group 220A and positive electrode terminal 320.

### (Configuration of Electrode Assembly 200)

FIG. 5 is a front view showing negative electrode plate 210. As shown in FIG. 5, a negative electrode tab 211 constituted of a negative electrode core body is provided at one end portion of negative electrode plate 210. When negative electrode plates 210 are stacked, negative electrode tabs 211 are stacked to form negative electrode tab group 210A. In a portion corresponding to the main body portion of electrode assembly 200, a negative electrode active material layer 212 is provided on negative electrode plate 210.

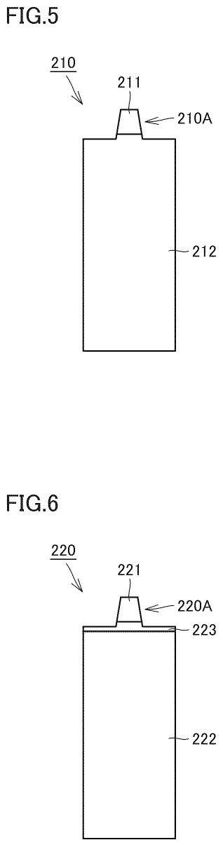

FIG. 6 is a front view showing positive electrode plate 220. As shown in FIG. 6, a positive electrode tab 221 constituted of a positive electrode core body is provided at one end portion of positive electrode plate 220. When positive electrode plates 220 are stacked, positive electrode tabs 221 are stacked to form positive electrode tab group 220A. In a portion corresponding to the main body portion of electrode assembly 200, a positive electrode active material layer 222 is provided on positive electrode plate 220. A positive electrode protective layer 223 is provided at the root of positive electrode tab 221. Positive electrode protective layer 223 may not be necessarily provided.

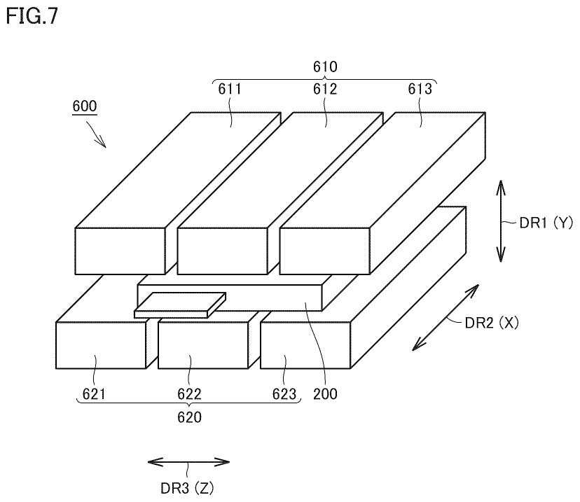

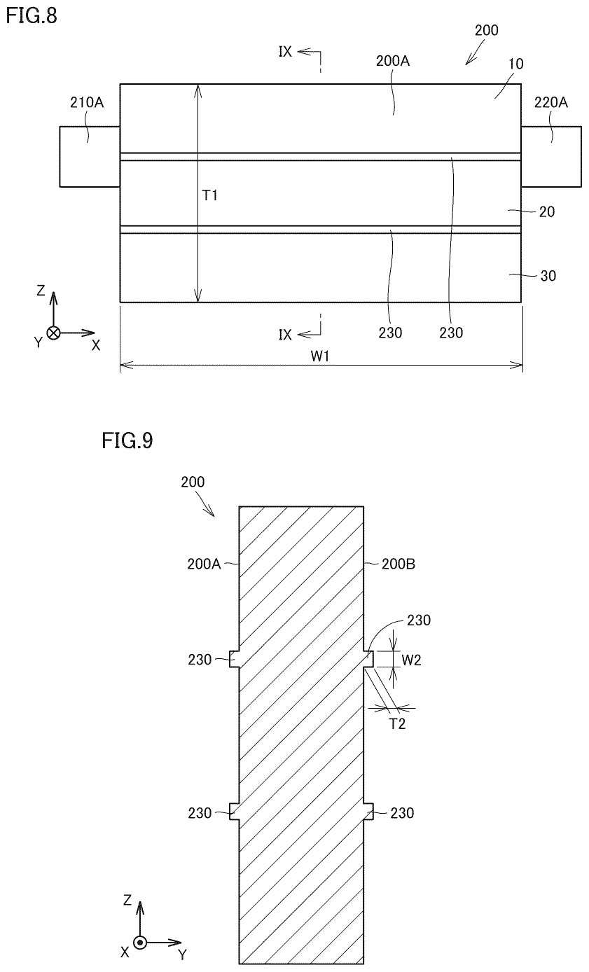

FIG. 7 is a diagram showing a step of pressing electrode assembly 200 in a method of manufacturing secondary battery 1. FIG. 8 is a front view showing electrode assembly 200 having been through the pressing step shown in FIG. 7. FIG. 9 is a cross sectional view along IX-IX in FIG. 8.

After electrode assembly 200 including negative electrode plate 210, positive electrode plate 220, and separator 240 is prepared (stacking step), electrode assembly 200 is pressed along a DR1 direction (first direction) (pressing step) as shown in FIG. 7. In the example of FIG. 7, the DR1 direction corresponds to the Y direction of electrode assembly 200. The pressing step is performed using a jig 600. Jig 600 is constituted of jigs 610, 620 facing each other with electrode assembly 200 being interposed therebetween.

Jig 610 has: a first portion 611 that presses a portion (first region 10) of electrode assembly 200; a second portion 612 that presses a region (second region 20) different from the region pressed by first portion 611; and a third portion 613 that presses a region (third region 30) different from the regions pressed by first portion 611 and second portion 612.

Jig 620 has: a first portion 621 facing first portion 611 of jig 610; a second portion 622 facing second portion 612 of jig 610; and a third portion 623 facing third portion 613 of jig 610.

Electrode assembly 200 is pressed between jigs 610, 620. For example, second portion 612 of jig 610 and second portion 622 of jig 620 can also be used to transport electrode assembly 200 before the pressing step and after the pressing step. Moreover, heat may be applied to electrode assembly 200 via jigs 610, 620 during the pressing step.

Therefore, it is possible to separately press the plurality of regions (three regions, i.e., first region 10 to third region 30 in the example of FIGS. 7 to 9; however, the number of the “plurality of regions” is not limited to three, and may be two or may be four or more) of electrode assembly 200. The pressing of the plurality of regions may be performed simultaneously or sequentially. After the step of pressing electrode assembly 200, an assembling step including insertion of electrode assembly 200 into case 100 is performed, thereby completing secondary battery 1.

Each of first portions 611, 621, second portions 612, 622, and third portions 613, 623 is formed along a DR2 direction (second direction). First portions 611, 621, second portions 612, 622, and third portions 613, 623 are disposed side by side in a DR3 direction (third direction) orthogonal to the DR2 direction. In the example of FIG. 7, the DR2 direction and the DR3 direction respectively correspond to the X direction and the Z direction of electrode assembly 200.

In the example of FIG. 7, slight clearances are provided at respective boundary portions between first portions 611, 621 and second portions 612, 622, and at respective boundary portions between second portions 612, 622 and third portions 613, 623. Therefore, as shown in FIGS. 8 and 9, in outer surfaces 200A, 200B of electrode assembly 200, projecting portions 230 (press marks) are formed at a boundary region between first region 10 and second region 20 and a boundary region between second region 20 and third region 30.

FIG. 8 illustrates exemplary projecting portions 230 formed entirely across the main body portion of electrode assembly 200 in the X direction, but projecting portions 230 may not necessarily be formed entirely across the main body portion of electrode assembly 200 in the X direction. For example, each of projecting portions 230 preferably has a length (when projecting portion 230 is intermittently formed, a length, in the X direction, including the portion at which projecting portion 230 is interrupted), in the X direction, of about 85% or more (more preferably about 90% or more, and further preferably about 95% or more) of the size (W1) of the main body portion of electrode assembly 200 in the X direction. In one example, projecting portion 230 is formed in a region in which positive electrode active material layer 222 is provided.

Projecting portion 230 may not be necessarily formed continuously in the X direction as shown in FIG. 8, and may be formed intermittently. Moreover, projecting portion 230 may include a portion slightly inclined with respect to the X direction.

FIG. 9 illustrates an example in which projecting portions 230 having substantially the same shape are formed at substantially the same positions on outer surface 200A (first outer surface) and outer surface 200B (second outer surface) facing each other, but the shapes of projecting portions 230 may be different or the positions at which projecting portions 230 are formed may be different on outer surfaces 200A, 200B.

Further, projecting portion 230 formed in the boundary region between first region 10 and second region 20 and projecting portion 230 formed in the boundary region between second region 20 and third region 30 may have shapes (planar shapes or cross sectional shapes) different from each other.

In the present embodiment, each of outer surfaces 200A, 200B of electrode assembly 200 has a substantially rectangular shape including a long-side direction corresponding to the X direction and a short-side direction corresponding to the Z direction. In one example, the size (W1) of outer surface 200A in the long-side direction is preferably about 275 mm or more (more preferably about 280 mm or more), and W1 is preferably about 300 mm or less (more preferably about 295 mm or less). In one example, the size (T1) of outer surface 200A in the short-side direction is preferably about 85 mm or more (more preferably about 87 mm or more), and T1 is preferably about 90 mm or less (more preferably about 88 mm or less).

In one example, the size (W1) of outer surface 200A of electrode assembly 200 in the long-side direction is preferably about three times or more as large as the size (T1) thereof in the short-side direction, and W1 is preferably about four times or less as large as T1. W1 is more preferably about 3.5 times as large as T1.

In one example, the area (W1×T1) of outer surface 200A of electrode assembly 200 is preferably about 23000 mm² or more (more preferably about 24000 mm² or more), and W1×T1 is preferably about 27000 mm² or less (more preferably about 25000 mm² or less).

However, the sizes (W1, T1, W1:T1, W1×T1) of outer surface 200A of electrode assembly 200 are not limited to the above ranges.

As shown in FIG. 9, projecting portion 230 has a predetermined width (W2) in the Z direction, and protrudes from outer surface 200A so as to have a predetermined protruding height (T2) in the Y direction. In one example, the width (W2) of projecting portion 230 is preferably about 10 μm or more (more preferably 20 μm or more, 30 μm or more, or 35 μm or more), and W2 is preferably about 200 μm or less (more preferably 180 μm or less, 160 μm or less, or 150 μm or less). In one example, the protruding height (T2) of projecting portion 230 from outer surface 200A is preferably about 0.5 μm or more (more preferably, 1 μm or more, 1.5 μm or more, or 2 μm or more), and T2 is preferably about 50 μm or less (more preferably, 40 μm or less, 30 μm or less, or 25 μm or less). However, the width (W2) or the protruding height (T2) of projecting portion 230 is not limited to the above range.

The plurality of regions (first region 10 to third region 30) in outer surfaces 200A, 200B are preferably pressed by substantially the same pressure. However, the pressing pressures in the plurality of regions may be slightly different (preferably within a range of about +5%).

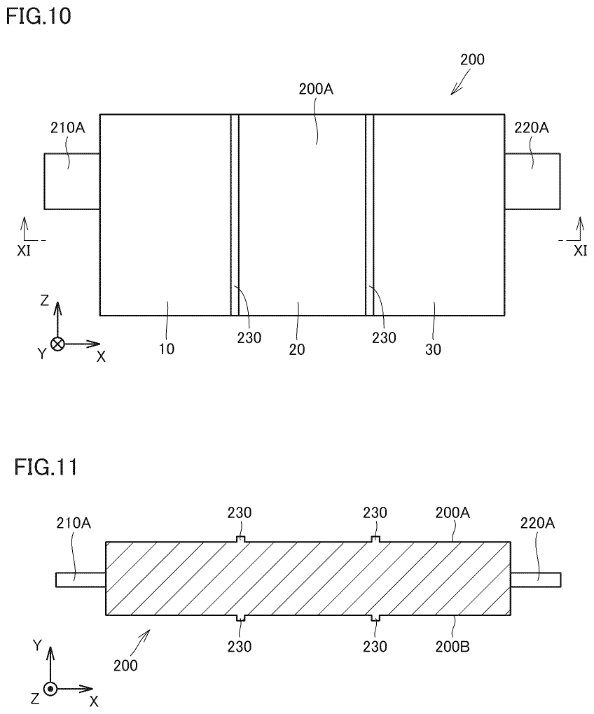

FIG. 10 is a front view showing an electrode assembly 200 according to a modification. FIG. 11 is a cross sectional view along XI-XI in FIG. 10. As shown in FIGS. 10 and 11, projecting portion 230 may be formed to extend in the Z axis direction. Further, both of projecting portion 230 extending in the X axis direction and projecting portion 230 extending in the Z axis direction may be formed. Moreover, projecting portion 230 may be formed to extend in any oblique direction intersecting the X axis direction and the Z axis direction. The extending direction of projecting portion 230 can be freely adjusted by adjusting the shape of jig 600 used in the pressing step.

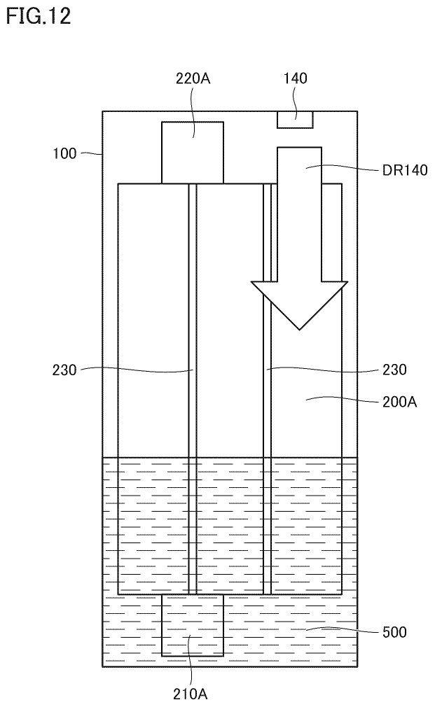

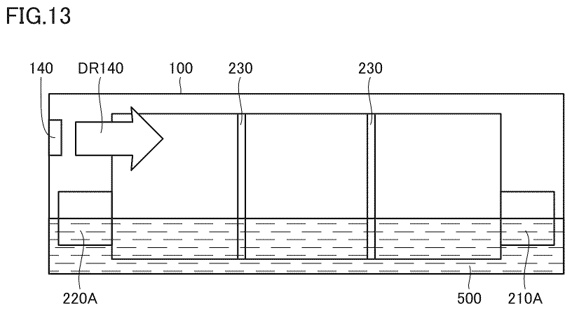

Each of FIGS. 12 and 13 is a diagram showing a step of injecting electrolyte solution 500. FIG. 12 shows the injection step when electrode assembly 200 illustrated in FIGS. 8 and 9 is used, whereas FIG. 13 shows the injection step when electrode assembly 200 illustrated in FIGS. 10 and 11 is used.

As shown in FIGS. 12 and 13, electrolyte solution 500 is injected into case 100 in a DR140 direction from injection hole 140 provided in case 100 (sealing plate 130). On this occasion, case 100 is preferably placed such that projecting portion 230 formed on electrode assembly 200 faces in a substantially vertical direction (direction in which gravity is exerted). Since a void in electrode assembly 200 (particularly, in separator 240) is relatively large at projecting portion 230, impregnation thereof with electrolyte solution 500 is likely to be promoted by a capillary phenomenon. Therefore, by placing electrode assembly 200 such that projecting portion 230 faces substantially in the vertical direction during the injection step, the impregnation of electrode assembly 200 with electrolyte solution 500 through projecting portion 230 can be promoted, thereby improving the injection property.

In the example of FIG. 12, injection hole 140 is provided at a position facing electrode assembly 200 in the direction (X direction) in which projecting portion 230 extends. In the example of FIG. 13, injection hole 140 is provided at a position facing electrode assembly 200 in the direction orthogonal to the direction (Y direction) in which projecting portion 230 extends. In either case, the impregnation of electrode assembly 200 with electrolyte solution 500 can be promoted through projecting portion 230.

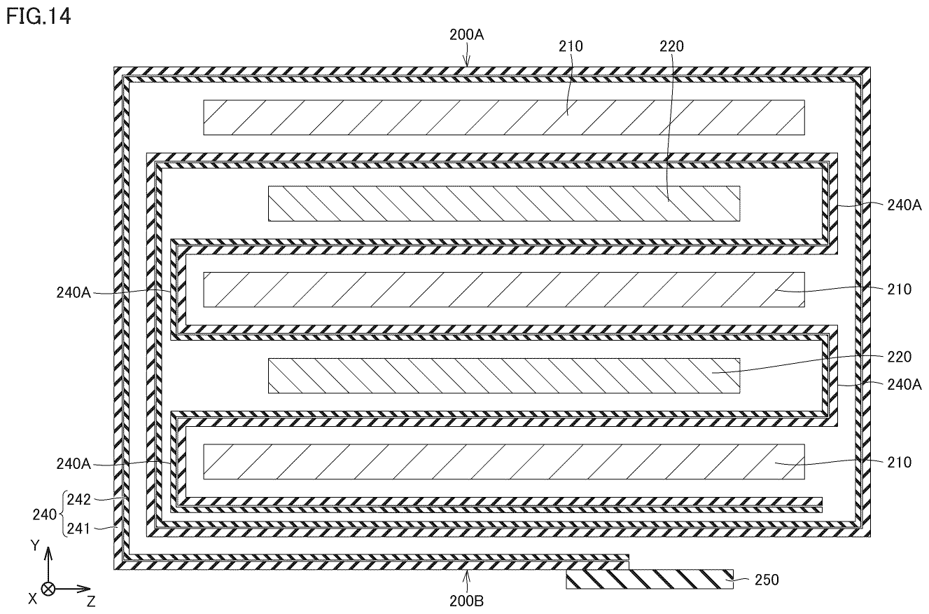

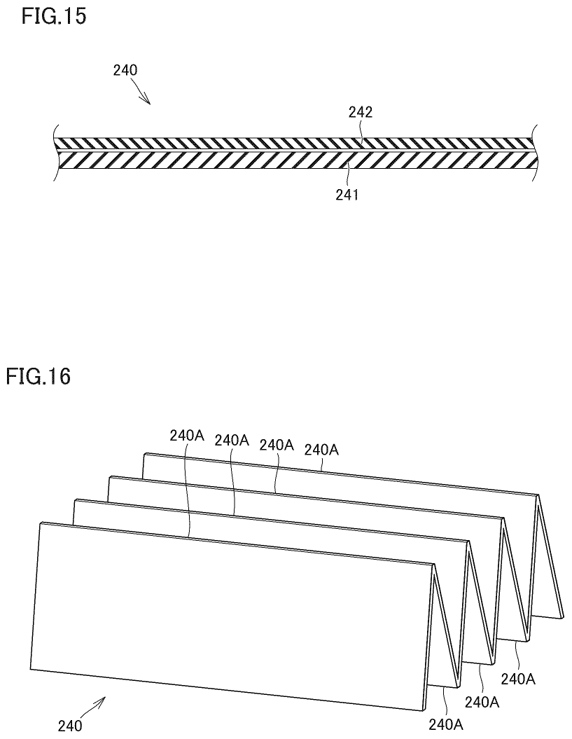

FIG. 14 is a cross sectional view schematically showing the structure of electrode assembly 200. FIG. 15 is a cross sectional view showing a structure of separator 240 included in electrode assembly 200. FIG. 16 is a diagram showing separator 240 folded in a meandering manner.

In the example shown in FIGS. 14 to 16, electrode assembly 200 is a stacked type electrode assembly in which the plurality of negative electrode plates 210 and the plurality of positive electrode plates 220 are alternately stacked with separator 240, which is folded in the meandering manner, being interposed therebetween. Separator 240 is folded at folding lines 240A. Each of folding lines 240A extends in the X direction. On outer surface 200B, an end portion of separator 240 is fixed by a tape 250 (fixing member). As one modification, electrode assembly 200 may be a wound type electrode assembly in which a stack of an elongated positive electrode plate and an elongated negative electrode plate is wound with separator 240 being interposed therebetween.

As shown in FIGS. 14 and 15, separator 240 includes: a main body layer 241 composed of a resin; and an adhesive layer 242 provided on main body layer 241. Main body layer 241 can be composed of, for example, a polyolefin microporous membrane. Adhesive layer 242 is melted by, for example, heat applied during the pressing step, and adheres separator 240 to negative electrode plate 210 and positive electrode plate 220.

Projecting portions 230 (press marks) formed on outer surfaces 200A, 200B of electrode assembly 200 may be formed only on separator 240 constituting outer surfaces 200A, 200B, or may be formed to reach negative electrode plate 210 or positive electrode plate 220 located on the inner side of electrode assembly 200 with respect to the outermost layer of separator 240.

Since projecting portion 230 is a region having not been through the step of pressing electrode assembly 200, a degree of adhesion or close contact among negative electrode plates 210, positive electrode plates 220, and the layers of separator 240 is relatively low at projecting portion 230. Moreover, a relatively large void is likely to remain in separator 240 at projecting portion 230. Therefore, the property of impregnation thereof with electrolyte solution 500 is improved in the region in which projecting portion 230 is formed.

In the example shown in FIG. 14, three layers of separator 240 are layered on outer surface 200B, but the scope of the present technology is not limited thereto, and only one or two layers of separator 240 may be layered at the outermost layer of electrode assembly 200, or four or more layers may be layered thereat.

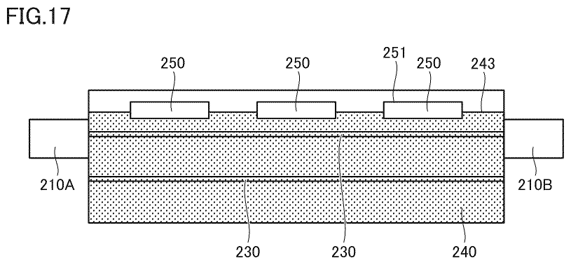

FIG. 17 is a diagram showing a positional relation between projecting portion 230 and each of stepped portions 243, 251 of separator 240. As shown in FIG. 17, in the outermost surface (outer surface 200B) of electrode assembly 200, stepped portion 243 is formed between a portion (dotted portion in FIG. 17) at which the three layers of separator 240 are layered and a portion at which two layers of separator 240 are layered. Projecting portion 230 in the present embodiment is different from stepped portion 243 of separator 240 and stepped portion 251 at the edge portion of tape 250. Projecting portion 230 is preferably formed at a position different from those of stepped portions 243, 251.

According to secondary battery 1 according to the present embodiment, since the property of impregnation thereof with electrolyte solution 500 can be improved in the region in which projecting portion 230 of electrode assembly 200 is formed, the injection property for electrolyte solution 500 can be improved. Moreover, by setting the sizes, such as the width (W2) and the protruding height (T2), of projecting portion 230 to fall within the predetermined ranges, it is possible to suppress electrode assembly 200 from being affected by the formation of projecting portion 230. As a result, it is possible to obtain secondary battery 1 with high reliability to suppress unintended precipitation of metal in electrode assembly 200.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A secondary battery comprising an electrode assembly including an electrode and a separator, the electrode assembly having a first outer surface substantially orthogonal to a first direction, wherein
a projecting portion protruding from the first outer surface and extending in a form of a line along a second direction in the first outer surface is formed on the first outer surface.

2. The secondary battery according to claim 1, wherein a width of the projecting portion in a third direction orthogonal to the second direction in the first outer surface is 10 μm or more and 200 μm or less.

3. The secondary battery according to claim 1, wherein a protruding height of the projecting portion from the first outer surface is 0.5 μm or more and 50 μm or less.

4. The secondary battery according to claim 1, wherein
the first outer surface has a substantially rectangular shape including a long-side direction and a short-side direction, and
the projecting portion is formed along the long-side direction.

5. The secondary battery according to claim 1, wherein the projecting portion is formed to reach the electrode located on an inner side of the electrode assembly with respect to the first outer surface in the first direction.

6. The secondary battery according to claim 1, wherein the first direction and the second direction are substantially orthogonal to each other.

7. The secondary battery according to claim 1, further comprising a case that accommodates the electrode assembly, wherein
the case is provided with an injection hole for injecting an electrolyte solution, and
the injection hole is provided in a surface of the case facing an end portion of the electrode assembly in the second direction.

8. The secondary battery according to claim 1, wherein three or more layers of the separator are layered at an outermost layer of the electrode assembly.

9. The secondary battery according to claim 1, wherein the separator includes a main body layer composed of a resin and an adhesive layer provided on the main body layer.

10. The secondary battery according to claim 1, wherein
the electrode assembly includes a negative electrode tab provided at a first end portion of the electrode assembly in the second direction, and a positive electrode tab provided at a second end portion of the electrode assembly in the second direction, and
the projecting portion is formed in the first outer surface at a position overlapping the negative electrode tab and the positive electrode tab in a third direction orthogonal to the second direction.

11. The secondary battery according to claim 1, wherein
the electrode assembly includes a negative electrode tab provided at a first end portion of the electrode assembly in the second direction, and a positive electrode tab provided at a second end portion of the electrode assembly in the second direction, and
the projecting portion is formed in the first outer surface at a position separated from the negative electrode tab and the positive electrode tab in a third direction orthogonal to the second direction.

12. The secondary battery according to claim 1, wherein
the first outer surface has a substantially rectangular shape including a long-side direction corresponding to the second direction and a short-side direction corresponding to a third direction orthogonal to the second direction,
an area of the first outer surface is 23000 mm² or more and 27000 mm² or less, and
a size of the first outer surface in the second direction is three times or more and four times or less as large as a size of the first outer surface in the third direction.

13. The secondary battery according to claim 1, wherein
a width of the projecting portion in a third direction orthogonal to the second direction in the first outer surface is 10 μm or more and 200 μm or less,
a protruding height of the projecting portion from the first outer surface is 0.5 μm or more and 50 μm or less,
the first outer surface has a substantially rectangular shape including a long-side direction and a short-side direction,
the projecting portion is formed along the long-side direction,
the projecting portion is formed to reach the electrode located on an inner side of the electrode assembly with respect to the first outer surface in the first direction, and
the first direction and the second direction are substantially orthogonal to each other,
the secondary battery further comprising a case that accommodates the electrode assembly, wherein
the case is provided with an injection hole for injecting an electrolyte solution,
the injection hole is provided in a surface of the case facing an end portion of the electrode assembly in the second direction,
three or more layers of the separator are layered at an outermost layer of the electrode assembly,
the separator includes a main body layer composed of a resin and an adhesive layer provided on the main body layer,
the electrode assembly includes a negative electrode tab provided at a first end portion of the electrode assembly in the second direction, and a positive electrode tab provided at a second end portion of the electrode assembly in the second direction,
the projecting portion is formed in the first outer surface at a position overlapping the negative electrode tab and the positive electrode tab in the third direction orthogonal to the second direction,
the first outer surface has the substantially rectangular shape including the long-side direction corresponding to the second direction and the short-side direction corresponding to the third direction,
an area of the first outer surface is 23000 mm² or more and 27000 mm² or less, and
a size of the first outer surface in the second direction is three times or more and four times or less as large as a size of the first outer surface in the third direction.

14. The secondary battery according to claim 1, wherein
a width of the projecting portion in a third direction orthogonal to the second direction in the first outer surface is 10 μm or more and 200 μm or less,
a protruding height of the projecting portion from the first outer surface is 0.5 μm or more and 50 μm or less,
the first outer surface has a substantially rectangular shape including a long-side direction and a short-side direction,
the projecting portion is formed along the long-side direction,
the projecting portion is formed to reach the electrode located on an inner side of the electrode assembly with respect to the first outer surface in the first direction, and
the first direction and the second direction are substantially orthogonal to each other,
the secondary battery further comprising a case that accommodates the electrode assembly, wherein
the case is provided with an injection hole for injecting an electrolyte solution,
the injection hole is provided in a surface of the case facing an end portion of the electrode assembly in the second direction,
three or more layers of the separator are layered at an outermost layer of the electrode assembly,
the separator includes a main body layer composed of a resin and an adhesive layer provided on the main body layer,
the electrode assembly includes a negative electrode tab provided at a first end portion of the electrode assembly in the second direction, and a positive electrode tab provided at a second end portion of the electrode assembly in the second direction,
the projecting portion is formed in the first outer surface at a position separated from the negative electrode tab and the positive electrode tab in the third direction orthogonal to the second direction,
the first outer surface has the substantially rectangular shape including the long-side direction corresponding to the second direction and the short-side direction corresponding to the third direction,
an area of the first outer surface is 23000 mm² or more and 27000 mm² or less, and
a size of the first outer surface in the second direction is three times or more and four times or less as large as a size of the first outer surface in the third direction.

15. A method of manufacturing a secondary battery, the method comprising:
preparing an electrode assembly including an electrode and a separator; and
pressing the electrode assembly along a first direction, wherein
the pressing the electrode assembly includes separately pressing a first region of the electrode assembly and a second region of the electrode assembly between which a boundary portion is sandwiched, so as to form a projecting portion protruding from a first outer surface of the electrode assembly in the boundary portion.
